(19) United States
(12) Patent Application Publication
(10) Pub. No.: US 2025/0378488 A1
(43) Pub. Date: Dec. 11, 2025

(54) SYSTEM AND METHOD FOR TRADE FINANCE OPERATIONS AND SANCTIONS SCREENING PROCESS

(71) Applicants: Mariya George, Ladera Ranch, CA (US); Chandrasekhar Somasekhar, Ladera Ranch, CA (US); Sarath Sasikumar, Ladera Ranch, CA (US)

(72) Inventors: Mariya George, Ladera Ranch, CA (US); Chandrasekhar Somasekhar, Ladera Ranch, CA (US); Sarath Sasikumar, Ladera Ranch, CA (US)

(73) Assignee: Cleartrade.ai, Inc., Ladera Ranch, CA (US)

(21) Appl. No.: 19/302,336

(22) Filed: Aug. 18, 2025

Related U.S. Application Data
(63) Continuation-in-part of application No. 18/270,541, filed on Jun. 30, 2023, now abandoned.
(60) Provisional application No. 63/254,533, filed on Oct. 12, 2021.

(51) Int. Cl. G06Q 40/02; G06F 16/353; G06F 40/186; G06F 40/30; G06V 30/10; G06V 30/414

(52) U.S. Cl. CPC G06Q 40/024; G06F 16/353; G06F 40/186; G06F 40/30; G06V 30/10; G06V 30/414

(57) ABSTRACT

The present invention discloses a system and method for processing trade finance documents and performing automated compliance screening. The system comprises a computing device, and a database for storing trade finance documents. The system processes documents using OCR to extract text and positional data, generating structured document representations via a layout-aware AI model. An AI classifier module categorizes documents based on content, layout, and domain-specific roles, while a semantic verification module aligns document data with master Letter of Credit templates. A rule management module validates compliance against international trade standards, and a financial crime risk control module performs real-time checks against external sanctions, vessel, and dual-use goods databases. The system further determines and reports discrepancies, anomalies, and compliance issues. The system supports heterogeneous layouts, multi-language documents, and integration with banking APIs.

### CROSS REFERENCE TO RELATED APPLICATIONS

The present application is a continuation-in-part of the U.S. patent application Ser. No. 18/270,541 filed on Jun. 30, 2023, which further claims the benefit of PCT Application PCT/US22/43401 filed on Sep. 14, 2022, and which further claims the benefit of U.S. Patent Application No. 63/254,533 filed Oct. 12, 2021, entitled “Digital Workbench for Trade Finance Operation” the contents of which is hereby incorporated by reference.

### TECHNICAL FIELD

The present invention generally relates to trade financing services. More specifically, the present invention relates to a system and method for trade finance operations and sanctions screening process, thereby improving the effectiveness and efficacy of trade finance operations.

### BACKGROUND

The financial service industry performs trade finance operations to facilitate international trade and commerce. It is possible and easier for financial service industries such as banks, trade finance companies, importers and exporters, agencies, and service providers to transact business through trade finance. The major function of trade finance is to remove the payment risk and the supply risk during transactions.

In today's global market, the financial service industries utilize several financial applications to process financial transactions, financial information, and sanction screening processes. These financial service industries establish a centralized system for processing financial applications and other financial data. The number of financial transactions and financial information used by financial service providers has grown at a staggering rate. At the same time, the need to manage and analyze the data from different financial applications has become essential.

Typically, trade finance powers more than 80% of the world's international trade. However, it is also increasingly identified as a potential conduit for money laundering and vulnerable to a breach of sanctions regulations. Stringent regulatory scrutiny and compliance requirements leave banks exposed to significant operational risks in terms of reputational damages and fines.

Many existing systems use various systems and methods of processing digital financial transactions through Artificial intelligence (AI) to overcome such drawbacks. Few existing patent references attempt to address the problems cited in the background as prior art over the presently disclosed subject matter are explained as follows:

A prior art WO 2021231408 A1 to James Toffey, et. al., entitled “Systems and methods for digitization and trading of trade finance assets” discloses methods and systems include a trade finance digital asset platform that generally provides improved visibility, security, and workflow execution for a set of trade finance transactions enabling capabilities for trade finance asset digitization, a trade finance data object model, interfaces to systems used by parties to trade finance transactions, event and state reporting services, and smart contract services that optionally operate using a blockchain.

Another prior art U.S. Ser. No. 10/628,828 B2 to Jose Caldera, entitled “Systems and methods for sanction screening” discloses a computerized sanction screening system may include an automated system for collection of sanction information, and a routine for analyzing additional available data related to sanction information entities. The system may also include an automated analysis summary routine for creating condensed information subsets or graphlets containing relevant information about sanction entities, some of which can be entities themselves, organized in a data retrieval system, such that an automated transaction system can check data from transactions and automatically identify and flag potentially sanctioned transactions. Then upon exceeding a preset contextual limit, a potential blocking warning is issued.

Yet another prior art U.S. Ser. No. 10/109,010 B2 to Denis Ignatovich, et. al., entitled “System and method for modeling and verifying financial trading platforms” discloses a computer-implemented method assesses operation of a financial computing system (FCS). An assessment computer system generates code for a model of the FCS that comprises a model specification for the FCS and a model environment for the FCS. The code for the model uses a type-system based logical programming language that supports typed recursive functions. The assessment computer system generates mathematical axioms that describe the operation of the FCS by compiling the code for the model and assesses the operation of the financial computer system by analyzing the mathematical axioms.

These existing systems are mainly used in limiting financial business losses but do not increase the efficiency and accuracy of the financial transactions at a high level. Also, there is no standard way of mentioning Goods and services along with the metadata ex, price, HS Code, incoterms etc. In addition, extracting goods/services and its metadata from Invoices, and packing list is complex due to the lack of a standard template or table structure that is followed across trade documents. Further, description of Goods and services may not follow the same wordings across documents. While it comes naturally for a human to interpret it as the same, for an automated solution it's a challenging task.

Therefore, there is a need for a digital solution to process trade finance transaction documents and to perform automated validation and reconciliation of the information present in the documents. Also, there is a need for a system to improve risk coverage and compliance level. This helps to reduce the risk by reconciling the financial information of the exporter and importer.

### SUMMARY

The present invention discloses a system and method for processing trade finance documents and performing automated compliance screening. The system comprises a computing device comprising at least one processor and a memory storing a set of program modules. The system further comprises at least one database in communication with the computing device via a network. The database is configured to store a plurality of trade finance transaction documents. The system further comprises a user device associated with a user in communication with the computing device via the network. The user device is configured to upload trade finance transaction documents to the computing device.

In one embodiment, the user device is configured to upload trade finance transaction documents to the computing device. The user is allowed to register into the system using one or more user credentials to access the services provided by the computing device. The computing device is configured to receive and process finance transaction documents using an optical character recognition (OCR) module to extract textual elements along with their positional coordinates. The computing device is further configured to generate structured document data by associating extracted textual elements with corresponding spatial positions and document geometry using a layout-aware artificial intelligence (AI) model trained on document geometry and content position.

The computing device is further configured to execute, a preprocessing pipeline operably coupled to the processor and memory, to prepare the structured document data for classification. The computing device is further configured to jointly analyze textual content and spatial layout information of the document data to determine a category for the document using an AI classifier module. The AI classifier module operably coupled to the processor, comprises a multi-modal embedding layer configured to represent each textual element detected in the document as a combination of textual embeddings, two-dimensional spatial embeddings derived from the element's location on the page, and domain-role tags indicating the element's functional role in trade finance transactions, and a plurality of transformer encoder layers configured to compute self-attention over both the sequential order of the textual elements and their corresponding spatial positions to generate context-aware representations.

The computing device is further configured to classify the documents into predefined categories based on semantic content and metadata using the AI classifier module. The computing device is further configured to present a graphical interface on the user device enabling step-wise preview of document contents aligned with fields of a master Letter of Credit (LC) template. The computing device is further configured to verify the document data by comparing it with LC metadata using natural language processing (NLP)-based semantic matching models, via a semantic verification module operably coupled to the processor and memory.

The computing device is further configured to validate document data against stored rule sets comprising technical conditions derived from UCP 600, ISBP, and international trade standards, to detect compliance discrepancies, via a rule management module operably coupled to the processor and memory.

The computing device is further configured to initiate real-time compliance screening requests to external systems via a financial crime risk control module operably coupled to the processor and memory. The external system including sanctions screening platforms, vessel intelligence services, and dual-use goods databases. The financial crime risk control module correlates screening results with corresponding document segments of document data and logs the results for audit traceability. The financial crime risk control module is configured to send structured document data to the external system to perform real-time compliance screening.

The computing device is further configured to correlate screening results with corresponding document segments and log the results for audit traceability. The computing device is further configured to detect trade-based money laundering patterns, vessel-related sanctions, dual-use goods, and pricing anomalies by correlating extracted document data with external maritime intelligence, sanctions list, and regulatory databases;

The computing device is further configured to generate a discrepancy report comprising failed rule conditions, mismatched semantic values, and document source references, and export the report in a standard format.

The computing device is further configured to enable rule customization by users via a graphical rule authoring interface linked to the rule management module. The graphical rule authoring interface allows users to define, test, and deploy rule conditions into the rule management module.

The computing device is further configured to adaptively retrain the AI classifier module using human validation feedback stored in structured form and integrated into retraining cycles through dynamic sample reweighting. The system is configured to operate autonomously or semi-autonomously, handle heterogeneous layouts and multi-language financial documents, and integrate with banking systems via an application programming interface (API) layer.

The system further includes a user-initiated reclassification module configured to reassign documents to updated categories based on user input or continuous learning feedback. The system is further configured to perform completeness checks for various documents requested or received by the user or other transactional entities under different fields. The different fields include bill of exchange, commercial invoice, bill of lading, packing list, certification of origin, beneficiary's certificate and unclassified documents. The system uses a visual selection-based data capture interface to extract data from document regions without manual typing. The system further includes a document comparison engine that maps structured data fields to LC terms to identify semantic and numeric discrepancies. The system is further configured to generate a discrepancy report for the respective LC and associated trade documents and exports the discrepancy report in a standard format.

In one embodiment, the AI classifier module comprises a transformer-based architecture configured to jointly learn from textual content and spatial layout of trade finance documents. The AI classifier module is configured to embed token-level semantic information together with positional coordinates of each token to enable recognition of visual document structure. The AI classifier module includes the preprocessing pipeline configured to handle non-standard layouts, embedded tables, handwritten notes, and stamps within trade finance documents. The AI classifier module incorporates an adaptive learning loop that captures human validation data from a user interface for fine-tuning during retraining cycles. The adaptive learning loop applies dynamic sample reweighting to adapt to customer-specific document structures and compliance requirements.

In one embodiment, the AI classifier module is configured to generate domain-specific embeddings for trade finance documents. The embeddings comprising textual embeddings derived from the content of each token, spatial embeddings derived from the positional coordinates of the token within the document layout, and domain-role embeddings encoding functional trade finance attributes of the token, including document type roles, Letter of Credit (LC) field associations, and regulatory compliance indicators. The textual, spatial, and domain-role embeddings are fused into a unified multi-modal representation, enabling the AI classifier module to distinguish functionally equivalent terms across heterogeneous trade finance document formats.

The system further comprises a dynamic rules engine configured to apply both predefined rule sets derived from international trade standards, including UCP 600 and ISBP, and adaptive user-defined rules for trade finance document validation. The system further comprises a trade finance common data model configured to standardize and structure extracted document data into normalized domain-specific entities including Letter of Credit (LC) terms, shipment details, invoicing elements, and compliance attributes. The dynamic rules engine operates on the standardized trade finance data model to detect discrepancies, compliance exceptions, and semantic mismatches across heterogeneous trade finance document formats.

In one embodiment, a method is provided for processing trade finance documents and performing automated compliance screening. The method comprises providing a computing device comprising at least one processor and a memory storing a set of program modules, at least one database in communication with the computing device via a network, and a user device associated with a user in communication with the computing device via the network. The method includes configuring the user device to upload trade finance transaction documents to the computing device, and configuring the database to store a plurality of trade finance transaction documents.

The method further comprises receiving finance transaction documents and processing them using an optical character recognition (OCR) module to extract textual elements along with their positional coordinates. Structured document data is generated by associating the extracted textual elements with corresponding spatial positions and document geometry using a layout-aware artificial intelligence (AI) model trained on document geometry and content position.

The method includes executing a preprocessing pipeline, operably coupled to the processor and memory, to prepare the structured document data for classification. The textual content and spatial layout information of the document data are jointly analyzed to determine a category for the document using an AI classifier module. The AI classifier module comprises a multi-modal embedding layer configured to represent each textual element as a combination of textual embeddings, two-dimensional spatial embeddings derived from the element's page location, and domain-role tags indicating the element's functional role in trade finance transactions. The AI classifier module further includes a plurality of transformer encoder layers configured to compute self-attention over both the sequential order of textual elements and their corresponding spatial positions to generate context-aware representations.

The method proceeds by classifying the documents into predefined categories based on semantic content and metadata using the AI classifier module. A graphical interface is presented on the user device to enable a step-wise preview of document contents aligned with fields of a master Letter of Credit (LC) template. The document data is verified by comparing it with LC metadata using natural language processing (NLP)-based semantic matching models via a semantic verification module.

The method also includes validating the document data against stored rule sets comprising technical conditions derived from UCP 600, ISBP, and international trade standards to detect compliance discrepancies via a rule management module. Real-time compliance screening requests are initiated to external systems, including sanctions screening platforms, vessel intelligence services, and dual-use goods databases, via a financial crime risk control module. The screening results are correlated with corresponding document segments and logged for audit traceability.

The method further comprises detecting trade-based money laundering patterns, vessel-related sanctions, dual-use goods, and pricing anomalies by correlating extracted document data with external maritime intelligence, sanctions list, and regulatory databases. A discrepancy report is generated comprising failed rule conditions, mismatched semantic values, and document source references, and is exported in a standard format.

The method enables rule customization by users via a graphical rule authoring interface linked to the rule management module. The AI classifier module is adaptively retrained using human validation feedback stored in structured form and incorporated into retraining cycles through dynamic sample reweighting. The method is capable of operating autonomously or semi-autonomously, handling heterogeneous layouts and multi-language financial documents, and integrating with banking systems via an application programming interface (API) layer.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates an environment of a system for processing trade finance documents and performing automated compliance screening, according to an embodiment of the present invention.

FIG. 2 exemplarily illustrates an environment of a system for processing trade finance documents and performing automated compliance screening, according to another embodiment of the present invention.

FIG. 3 exemplarily illustrates an environment of a system for processing trade finance documents and performing automated compliance screening, according to yet another embodiment of the present invention.

FIG. 4 illustrates an example workflow for processing documents received under a letter of credit (LC) in a trade finance environment, according to an embodiment of the present invention.

FIG. 5 illustrates a workflow for document processing and trade-based money laundering (TBML) checks in a trade finance environment, according to an embodiment of the present invention.

FIG. 6 illustrates an architecture of a system for processing trade finance documents and performing automated compliance screening, according to yet another embodiment of the present invention.

FIG. 7 exemplarily illustrates a flowchart of a method for processing trade finance documents and performing automated compliance screening, according to an embodiment of the present invention.

### DETAILED DESCRIPTION OF EXAMPLE EMBODIMENTS

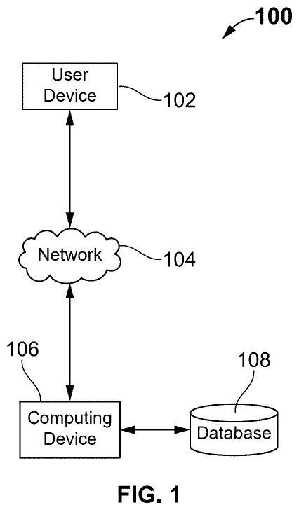

Referring to FIG. 1, a block diagram of a system executed in a computer-implemented environment 100 is disclosed. The system is configured to perform trade finance operations and sanctions screening process. In one embodiment, the system is an innovative and intelligent computer-implemented solution that has been designed to allow a bank or transactional entity to effectively and efficiently perform the trade finance operations and sanctions screening processes for their clients. The system enables the clients to reduce risks, improve throughput, and significantly reduce false positives and missed red flags. In one embodiment, the system improves throughput up to 70%. In one embodiment, the system is a digital workbench to process trade finance transaction documents. In one embodiment, the system is configured to perform automated reconciliation against UCP and ISBP rules and seamlessly integrate with sanctions screening and trade-based money laundering (TBML) systems.

In one embodiment, the system is an application software or mobile application or web-based application. In one embodiment, the application is executed in the computer-implemented environment or network environment 100. In one embodiment, the computer-implemented environment 100 comprises a user device 102 in communication with a computing device 106 via a network 104. The user device 102 is associated with a user or maker or banker. In one embodiment, the user device 102 is at least any one of a smartphone, a mobile phone, a laptop, a desktop, a tablet, or other suitable mobile and/or handheld electronic communication devices. The environment 100 further comprises a database 108 in communication with the computing device 106.

In one embodiment, the user device 102 comprises a storage medium in communication with the network 104 to access the computing device 106 via the network 104 configured to perform finance operations and sanctions screening operation. In one embodiment, the user is allowed to register into the system using one or more user credentials configured to access the services provided by the computing device 106. In an embodiment, the network 104 may be a Wi-Fi network, a WiMAX network, a local area network (LAN), a wide area network (WAN), and a wireless local area network (WLAN). In one embodiment, the database 108 is in communication with the computing device 106 via the network 104 configured to store a plurality of trade finance transaction documents.

In one embodiment, the computing device 106 comprises at least one processor and a memory in communication with the processor. The memory stores a set of instructions executable by the processor. In one embodiment, the computing device 106 receives the trade finance transaction documents uploaded by the user or any of transactional entities via the network 104 configured to classify the trade finance transaction documents under different groups/categories using at least one artificial intelligence classifier; preview each page of the document as per letter of credit (LC); verify the system extracted information from the uploaded documents, and validate one or more rules for each document to provide document scrutinization results based on Uniform Customs and Practice (UCP)/International Standard Banking Practice (ISBP)/Consistency rule checks, thereby performing automated reconciliation against UCP and ISBP rules and seamlessly integrate with sanctions screening and Trade Based Money Laundering (TBML) systems.

In one embodiment, the computing device 106 may be a server or cloud server. The server is configured to collect one or more parameters from the user device 102. In one embodiment, the server may be operated as a single computer. In some embodiments, the computer could be a touchscreen and/or non-touchscreen and adopted to run on any type of OS, such as iOS™ Windows™, Android™, Unix™, Linux™, and/or others. In one embodiment, the plurality of computers is in communication with each other, via the network 104. Such communication is established via a software application, a mobile app, a browser, an OS, and/or any combination thereof. In one embodiment, the computing device 106 comprises at least one processor and a memory in communication with the processor. The memory stores a set of instructions executable by the processor.

In one embodiment, the user device 102 is configured to upload trade finance transaction documents to the computing device 106. The user is allowed to register into the system using one or more user credentials to access the services provided by the computing device 106.

The computing device 106 is configured to receive and process finance transaction documents using an optical character recognition (OCR) module to extract textual elements along with their positional coordinates. The computing device 106 is further configured to generate structured document data by associating extracted textual elements with corresponding spatial positions and document geometry using a layout-aware artificial intelligence (AI) model trained on document geometry and content position.

The computing device 106 is further configured to execute, a preprocessing pipeline operably coupled to the processor and memory, to prepare the structured document data for classification. The computing device 106 is further configured to jointly analyze textual content and spatial layout information of the document data to determine a category for the document using an AI classifier module. The AI classifier module operably coupled to the processor, comprises a multi-modal embedding layer configured to represent each textual element detected in the document as a combination of textual embeddings, two-dimensional spatial embeddings derived from the element's location on the page, and domain-role tags indicating the element's functional role in trade finance transactions, and a plurality of transformer encoder layers configured to compute self-attention over both the sequential order of the textual elements and their corresponding spatial positions to generate context-aware representations.

The computing device 106 is further configured to classify the documents into predefined categories based on semantic content and metadata using the AI classifier module. The computing device 106 is further configured to present a graphical interface on the user device enabling step-wise preview of document contents aligned with fields of a master Letter of Credit (LC) template. The computing device 106 is further configured to verify the document data by comparing it with LC metadata using natural language processing (NLP)-based semantic matching models, via a semantic verification module operably coupled to the processor and memory.

The computing device 106 is further configured to validate document data against stored rule sets comprising technical conditions derived from UCP 600, ISBP, and international trade standards, to detect compliance discrepancies, via a rule management module operably coupled to the processor and memory.

The computing device 106 is further configured to initiate real-time compliance screening requests to external systems via a financial crime risk control module operably coupled to the processor and memory. The external system including sanctions screening platforms, vessel intelligence services, and dual-use goods databases. The financial crime risk control module correlates screening results with corresponding document segments of document data and logs the results for audit traceability. The financial crime risk control module is configured to send structured document data to the external system to perform real-time compliance screening.

The computing device 106 is further configured to correlate screening results with corresponding document segments and log the results for audit traceability. The computing device 106 is further configured to detect trade-based money laundering patterns, vessel-related sanctions, dual-use goods, and pricing anomalies by correlating extracted document data with external maritime intelligence, sanctions list, and regulatory databases;

The computing device 106 is further configured to generate a discrepancy report comprising failed rule conditions, mismatched semantic values, and document source references, and export the report in a standard format. The computing device 106 is further configured to enable rule customization by users via a graphical rule authoring interface linked to the rule management module. The graphical rule authoring interface allows users to define, test, and deploy rule conditions into the rule management module.

The computing device 106 is further configured to adaptively retrain the AI classifier module using human validation feedback stored in structured form and integrated into retraining cycles through dynamic sample reweighting. The system is configured to operate autonomously or semi-autonomously, handle heterogeneous layouts and multi-language financial documents, and integrate with banking systems via an application programming interface (API) layer.

The system provides financial crime risk controls including include sanctions screening, compliance checks, and trade-based money laundering (TBML) checks. The sanctions Screening involves verifying trade participants such as buyers, sellers, financial institutions, shipping companies, and vessels against international and domestic sanctions lists, including but not limited to those issued by the Office of Foreign Assets Control (OFAC), the European Union (EU), the United Nations (UN), and HM Treasury. The compliance Check encompasses broader regulatory and risk due diligence processes, including Know Your Customer (KYC) verification, Anti-Money Laundering (AML) assessments, Politically Exposed Persons (PEP) screening, and validation of adherence to jurisdiction-specific and international compliance frameworks.

The trade-based money laundering (TBML) Check represent a specialized form of financial crime risk assessment designed to detect money laundering or terrorism financing activity hidden within trade transactions. The TBML Checks identify anomalies such as over-invoicing, under-invoicing, phantom shipments, misrepresentation of goods in terms of type, quality, or quantity, and routing of transactions through high-risk jurisdictions. The features related to sanctions screening, compliance checks, and TBML checks are further explained in later sections of the description.

The system further includes a user-initiated reclassification module configured to reassign documents to updated categories based on user input or continuous learning feedback. The system is further configured to perform completeness checks for various documents requested or received by the user or other transactional entities under different fields. The different fields include bill of exchange, commercial invoice, bill of lading, packing list, certification of origin, beneficiary's certificate and unclassified documents.

The system uses a visual selection-based data capture interface to extract data from document regions without manual typing. The system further includes a document comparison engine that maps structured data fields to LC terms to identify semantic and numeric discrepancies. The system is further configured to generate a discrepancy report for the respective LC and associated trade documents and exports the discrepancy report in a standard format.

In some embodiments, the system includes an external financial crime risk control module configured to perform real-time compliance screening of extracted trade finance document data. The module is operatively coupled to the document processing and classification components and receives structured data elements, including party names, vessel identifiers, and goods descriptions, derived from the processed documents.

The module is configured to initiate screening requests to one or more external compliance systems, such as sanctions screening platforms, vessel intelligence services, and dual-use goods databases. In operation, the structured data is formatted into the required query structure for each external system and transmitted via secure communication protocols. The external systems return screening results, which may include matches to sanctioned entities, vessels with movement restrictions, or goods subject to export control regulations.

Upon receipt of the results, the external financial crime risk control module correlates each screening result with the corresponding segment of the source document from which the queried data was derived. This correlation is stored in association with the original document data to maintain contextual linkage. The module further logs the correlated results in an audit trail repository, enabling traceability of the screening process for regulatory compliance, internal review, or third-party audits.

In certain embodiments, the correlation process may include assigning unique identifiers to document segments and embedding screening result metadata into the document's structured data representation. This ensures that compliance findings can be retrieved alongside their source context during subsequent review or discrepancy reporting.

The AI classifier module used in the system is a deep learning-based model specifically optimized for processing unstructured trade finance documents. The classifier leverages a transformer-based architecture capable of jointly learning from the textual content of documents and their spatial layout. Unlike conventional text-only classifiers, the model embeds both token-level semantic information and the positional coordinates of each token within a document, enabling the system to understand and utilize visual document structure. This capability is particularly critical when processing scanned trade documents, including Letters of Credit (LCs), Invoices, Bills of Lading, and Packing Lists.

The AI classifier module is initially trained on a broad collection of document images and subsequently fine-tuned on a specialized dataset comprising thousands of manually annotated trade finance documents. These documents are labeled for multiple tasks at both the document and field levels, including document classification, entity recognition, and extraction of compliance-related information. The training process combines supervised learning techniques, used for classification and data extraction, with weak supervision techniques, in which domain-specific rules are applied to label large volumes of unlabeled documents. This hybrid approach improves performance on the diverse and non-standard document formats typically encountered in global trade.

A key aspect of the system is its domain-specific feature engineering. The preprocessing pipeline is designed to handle artifacts commonly found in trade documents, such as embedded tables, non-standard layouts, handwritten notes, and stamps. The pipeline identifies structured visual regions, such as boxed sections and table boundaries, and enhances token representations with features including contextual tags (e.g., banking, shipping, customs), positional embeddings reflecting the document hierarchy (e.g., section, page number, header/footer), and recognition of domain-specific financial terms using dedicated lexicons.

The classifier incorporates an adaptive learning loop that systematically captures human validation data from the user interface. This feedback is stored in a structured format and integrated into retraining cycles using dynamic sample reweighting. By incorporating human-in-the-loop feedback, the system gradually adapts to customer-specific document structures and evolving compliance requirements. The adaptive learning mechanism ensures that model updates remain controlled, auditable, and aligned with production-grade reliability standards.

Technically, the AI classifier module departs from traditional OCR-plus-rule engines and off-the-shelf document classifiers by employing a multi-modal embedding layer in which each token is represented as a combination of textual embeddings derived from OCR output, two-dimensional spatial embeddings based on normalized bounding box coordinates, and domain-role tags (e.g., issuer, beneficiary, shipping term). These embeddings are processed by a deep stack of transformer encoder layers, where self-attention is computed over both token sequences and their spatial positions, enabling the model to learn positional context and domain-specific document structure.

By integrating spatial, semantic, and domain-specific signals directly into the model architecture and training process, the system achieves contextual inference capabilities that encode domain expertise. This approach provides high-accuracy automation for complex trade documentation, offering advantages such as domain-aware feature representations, adaptive learning for regulatory compliance, and traceable updates aligned with operational requirements.

The platform orchestrates a multi-stage pipeline for compliance enforcement in trade finance document processing. At the first stage, an extraction layer is implemented wherein domain-tuned natural language processing (NLP) models within a Digitization module convert trade documents, including Letters of Credit (LCs), Bills of Lading (B/Ls), and invoices, into structured tokens, fields, and entities. At the subsequent pre-screening normalization stage, named entities such as parties, vessels, ports, and commodities are semantically normalized, deduplicated, and enriched to improve downstream matching accuracy and enhance the reliability of risk detection.

During the screening invocation stage, the Compliance engine transmits real-time screening requests to external systems either synchronously, in a blocking mode, or asynchronously, queued with callbacks, based on throughput requirements and service level agreements. Screening results, including matches, hits, and risk scores, are correlated with corresponding document segments in the alert correlation stage. Alerts are rendered in the analyst user interface and logged to ensure auditability and compliance traceability.

For risk detection and maritime intelligence, the platform applies advanced compliance logic to elevate red-flag detection. Trade-based money laundering (TBML) red flags are detected through domain-specific rule sets that identify high-risk goods, routing anomalies, dual-use items, and unusual pricing patterns. A user-driven workbench enables manual overrides and commentary, with all interactions captured in audit logs. Vessel verification is performed by validating extracted vessel data, such as International Maritime Organization (IMO) numbers, ownership information, and flag states, against maritime intelligence databases. Port calls and vessel activities are screened against sanctions lists in real time.

The system further comprises a dynamic rules engine configured to apply both predefined rule sets derived from international trade standards, including UCP 600 and ISBP, and adaptive user-defined rules for trade finance document validation. The system further comprises a trade finance common data model configured to standardize and structure extracted document data into normalized domain-specific entities including Letter of Credit (LC) terms, shipment details, invoicing elements, and compliance attributes. The dynamic rules engine operates on the standardized trade finance data model to detect discrepancies, compliance exceptions, and semantic mismatches across heterogeneous trade finance document formats.

The platform is integrated with sanctions screening platforms, vessel intelligence services, and dual-use goods databases, leveraging an API-first architecture that facilitates real-time, event-driven data exchange across these compliance ecosystems. The dynamic, configurable rules engine within the platform automatically identifies TBML and sanctions red flags by correlating extracted trade data, including vessel details, goods descriptions, and port codes, with external risk sources. The rules engine also translates LC terms into operational validation logic, allowing banks to configure geography-specific or client-specific rules without IT intervention.

The system unifies document digitization, regulatory screening, and TBML analysis in a seamless, end-to-end workflow. This integration enables contextual, trade-specific red-flag detection that goes beyond keyword recognition, applying logic to detect TBML patterns, pricing anomalies, dual-use goods, and vessel- or port-based sanctions violations by intelligently combining extracted document data with global risk signals.

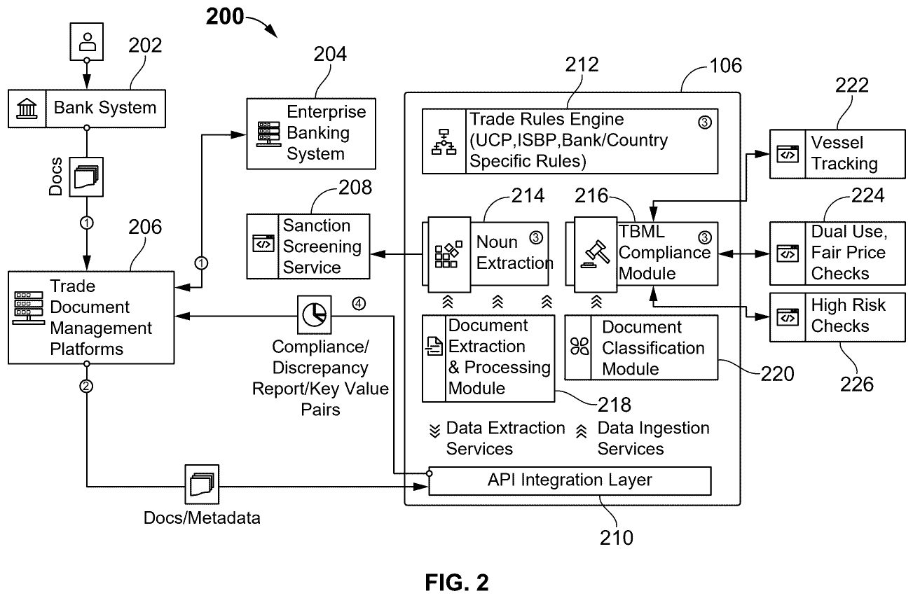

FIG. 2 exemplarily illustrates an environment 200 of a system for processing trade finance documents and performing automated compliance screening, according to another embodiment of the present invention. The environment 200 of the system comprises a bank system 202 that serves as the originating entity for trade finance transaction documents. The trade finance transaction documents include Letters of Credit, Bills of Lading, Invoices, Packing Lists, and other related trade paperwork. The bank system 202 transmits the trade documents either directly to an enterprise banking system 204 or to connected trade document management platforms 206 for further processing.

The trade document management platforms 206, such as Finastra® Eximbills, Trade360®, or Surecomp®, receive trade documents from the bank system 202. The trade document management platform 206 may store, organize, and manage trade documents and associated metadata, making them available for downstream processing. The enterprise banking system 204 receives trade documents from the bank system 202 for internal review, processing, and integration into banking workflows. The enterprise banking system 204 may initiate sanction screening or forward the documents to a compliance engine for further evaluation.

The environment 200 further comprises a sanction screening service 208 configured to compare extracted data from trade documents against international sanctions lists and watchlists. The sanction screening service 208 helps identify parties or entities that may be prohibited from participating in trade transactions. The environment 200 further comprises the computing device 106 that serves as the central processing engine for trade document compliance evaluation. The computing device 106 includes multiple submodules integrated through an API integration layer 210 to enable seamless data exchange with external systems and internal banking applications.

Further, a trade rules engine 212 applies compliance validation checks based on UCP 600, ISBP guidelines, and bank- or country-specific rules. The engine 212 analyzes structured data extracted from trade documents to detect compliance discrepancies and technical violations. Further, a noun extraction module 214 processes textual data to identify key entities, such as company names, vessel identifiers, goods descriptions, and monetary amounts. This structured data is used for downstream compliance checks and screening activities. Further, a trade-based money laundering (TBML) compliance module 216 analyzes trade transaction data to identify patterns indicative of TBML activities. It integrates with external intelligence services to detect vessel-related sanctions, dual-use goods, fair pricing anomalies, and other high-risk transaction indicators.

Further, a document extraction and processing module 218 converts incoming trade documents, whether scanned or digital, into structured data. This includes OCR processing, layout analysis, and semantic tagging to enable accurate classification and compliance evaluation. Further, a document classification module 220 applies AI models to categorize trade documents according to type (e.g., Letter of Credit, Invoice, Packing List) to ensure that appropriate compliance rules and checks are applied.

The system further specializes in parsing relevant fields from processed documents, linking them to spatial positions and metadata for precise compliance validation. Further, the API integration layer 210 facilitates secure and standardized data exchange between the system and external systems, including sanctions screening services, vessel tracking services, and other compliance databases.

The system further enables external vessel tracking 222, which provides real-time and historical location data for vessels associated with trade transactions, enabling the system to identify sanctioned or suspicious maritime activities. The system further provides a dual-use goods and fair price check service 224, which identifies goods with potential military applications or strategic significance, and cross-verifies declared prices against market benchmarks to detect over- or under-invoicing risks. The system further provides a high-risk entity check service 226, which screens transaction participants against databases of politically exposed persons (PEPs), high-risk jurisdictions, and adverse media listings.

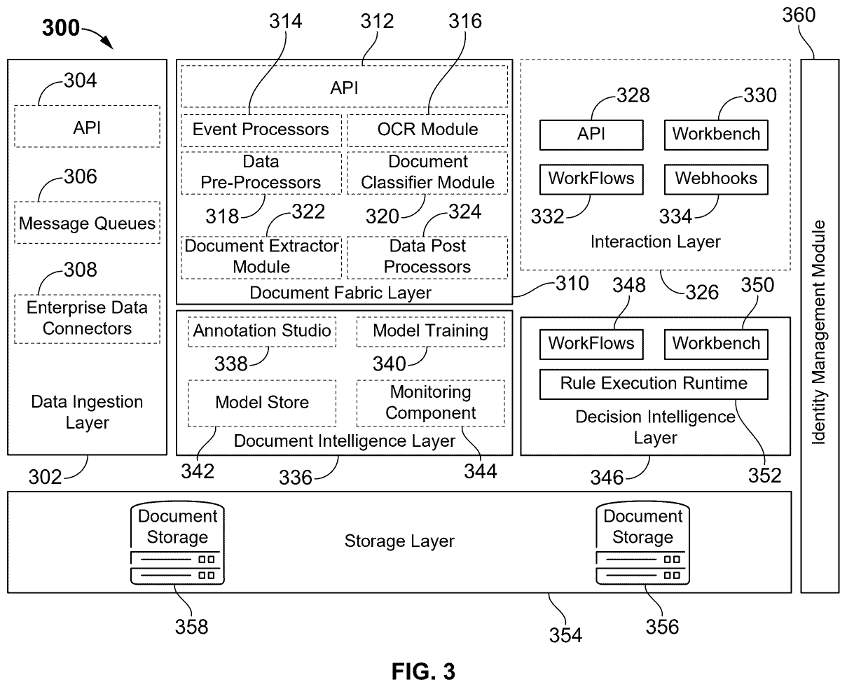

FIG. 3 exemplarily illustrates an environment 300 of a system for processing trade finance documents and performing automated compliance screening, according to yet another embodiment of the present invention. The system comprises a data ingestion layer 302 configured to receive, capture, and manage inbound data and documents from a plurality of sources. The data ingestion layer 302 includes an application programming interface API component 304 configured to enable standardized communication with external systems, a message queues component 306 configured to manage asynchronous data transfer and event-driven processing, and an enterprise data connectors component 308 configured to establish secure connections with enterprise banking systems, trade document repositories, and other third-party platforms.

The system further comprises a document fabric layer 310 configured to process, classify, and extract data from incoming documents. The document fabric layer 310 includes an API component 312, an event processor 314 for orchestrating event-driven document processing, and an optical character recognition OCR module 316 for converting image-based documents into machine-readable text. The document fabric layer 310 also includes a data pre-processors module 318 for preparing incoming document data, a document classifiers module 320 for applying AI-based classification to categorize documents, and a document extractors module 322 for extracting relevant field-level information from the classified documents. The data postprocessors 324 is further configured to normalize, enrich, and format the extracted data for downstream processing.

The system further comprises an interaction layer 326 configured to manage user and system interactions with the platform. The interaction layer 326 includes an API component 328 for exposing platform capabilities to external applications, a workbench component 330 for providing an interactive user interface for document review and validation, a workflows component 332 for defining and executing business process flows, and a webhooks component 334 for enabling event notifications to external systems.

The system further comprises a document intelligence layer 336 configured to support machine learning-based document understanding and continuous model improvement. The document intelligence layer 336 includes an annotation studio 338 for manual data labeling, a model training component 340 for training AI/ML models, a model store 342 for managing deployed models, and a monitoring component 344 for tracking model performance and operational metrics.

The system further comprises a decision intelligence layer 346 configured to enable rule-based decision-making on processed trade data. The decision intelligence layer 346 includes a workflows component 348 for executing automated decision workflows, a workbench component 350 for manual decision review, and a rule execution runtime 352 for evaluating business rules and compliance checks.

The system further comprises a storage layer 354 configured to store incoming and processed document data. The storage layer 354 includes a document storage component 356 for archiving original and processed document files, and a data storage component 358 for persisting structured data outputs and analytical datasets. The system further comprises an identity management module 360 configured to authenticate users, manage access control, and enforce security policies across all layers of the platform. The system further includes a task history profile associated with each transactional entity.

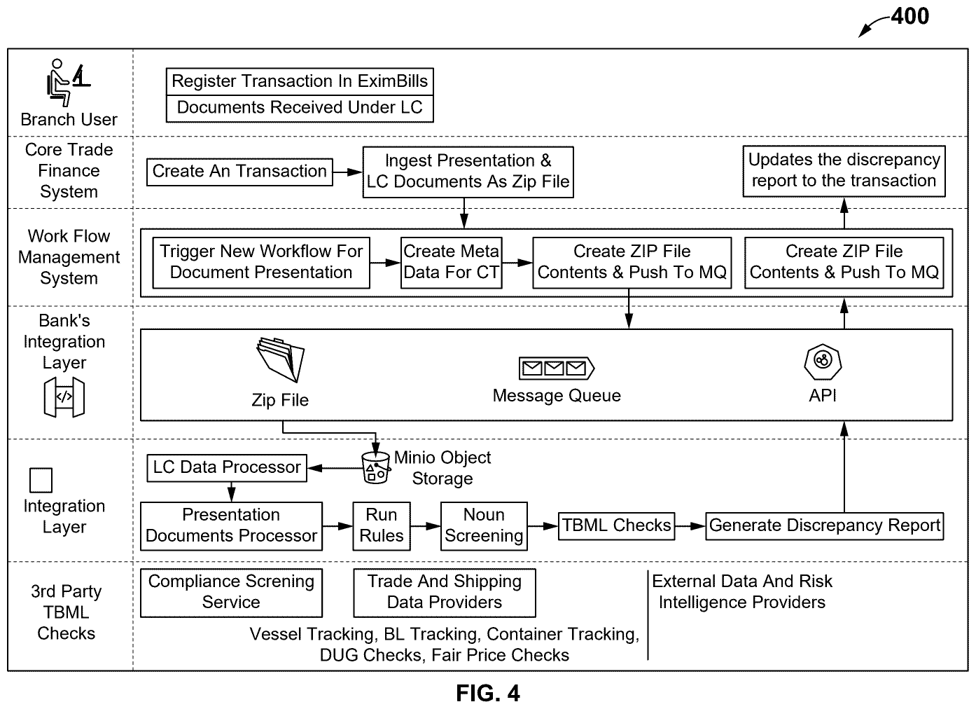

FIG. 4 illustrates an example workflow 400 for processing documents received under a letter of credit (LC) in a trade finance environment, according to an embodiment of the present invention.

The workflow begins with a branch user registering a transaction in a core trade finance system and marking documents as received under the LC. The branch user then creates a transaction, and the system ingests the presentation and LC documents as a zip file. A workflow engine triggers a new workflow for document presentation, generating metadata for the presentation and creating zip file contents, which are then pushed to a message queue. These files and associated data are passed through the bank's integration layer, where zip files are managed and routed to downstream processes.

In the integration layer, an LC data processor retrieves and stores the files in an object storage service. The presentation documents processor then processes the files, runs applicable rules, performs noun screening, and conducts trade-based money laundering (TBML) checks. Based on the results, the system generates a discrepancy report, which is updated back to the transaction record in the trade finance system.

The TBML checks may include integrations with third-party systems for vessel tracking, bill of lading (BL) tracking, container tracking, due diligence (DUG) checks, and fair price checks. Additional possible integrations may include various external data providers, compliance check services, and industry-specific information databases.

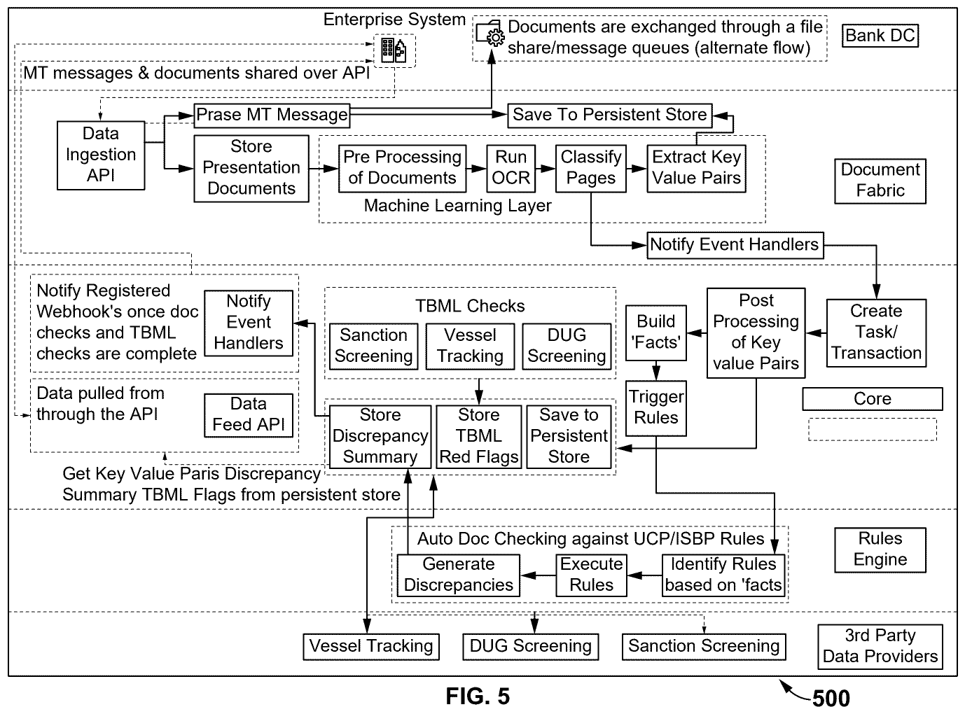

FIG. 5 illustrates a workflow 500 for document processing and trade-based money laundering (TBML) checks in a trade finance environment. The enterprise system exchanges messages and documents over an application programming interface (API) or, alternatively, through file share or message queues. a data ingestion API stores presentation documents, which are then pre-processed, subjected to optical character recognition (OCR), page classification, and key-value pair extraction using a machine learning layer. event handlers are notified upon completion of these steps. The extracted key-value pairs undergo post-processing before creating a task or transaction in a core processing system. TBML checks include sanction screening, vessel tracking, and dug screening. the results are stored as discrepancy summaries, TBML red flags, and in a persistent store.

A rules engine builds facts, triggers rules, and executes automated document checking against uniform customs and practice (UCP) or international standard banking practice (ISBP) rules, generating discrepancies where applicable. rules are identified and executed based on the established facts. Further, notifications are sent to registered webhooks when document checks and TBML checks are completed. A data feed API retrieves data, including key-value pair discrepancies and TBML flags, from the persistent store. TBML checks may also leverage third-party data providers for vessel tracking, dug screening, and sanction screening.

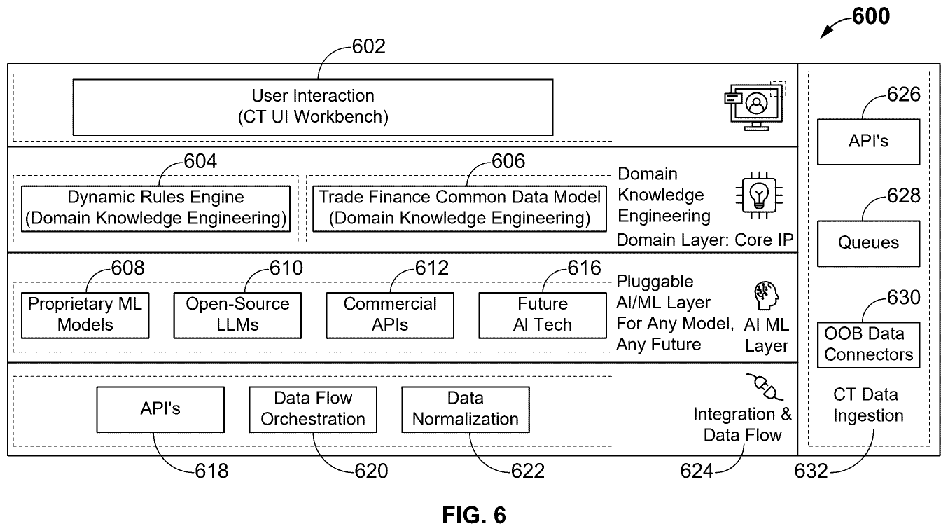

FIG. 6 illustrates an architecture 600 of a system for processing trade finance documents and performing automated compliance screening, according to yet another embodiment of the present invention.

The system includes a user interaction (CT UI workbench) 602 configured to provide an interface for users to access, monitor, and control system operations. A dynamic rules engine (domain knowledge engineering) 604 is configured to apply predefined and adaptive rules for trade finance processing, and a trade finance common data model (domain knowledge engineering) 606 is configured to standardize and structure trade finance-related data. The system includes proprietary ML models 608 execute machine learning operations for document and transaction analysis, while open-source LLMs 610 process natural language and extract contextual information. Commercial APIs 612 connect with external commercial services and systems, and future AI tech 616 provides integration capabilities for emerging artificial intelligence technologies. A pluggable AI/ML layer for any model, enables integration with various AI/ML models and frameworks for adaptability. APIs 618 facilitate programmatic interaction between system modules, while data flow orchestration 620 manages and coordinates the movement of data across components. Data normalization 622 transforms incoming data into a standardized format, and integration & data flow 624 supports interoperability and efficient data exchange. The architecture further includes APIs 626 positioned in a side module to connect with external systems, queues 628 to manage asynchronous message passing, OOB data connectors 630 to link with out-of-the-box data sources, and CT data ingestion 632 to capture and import trade finance-related data into the system.

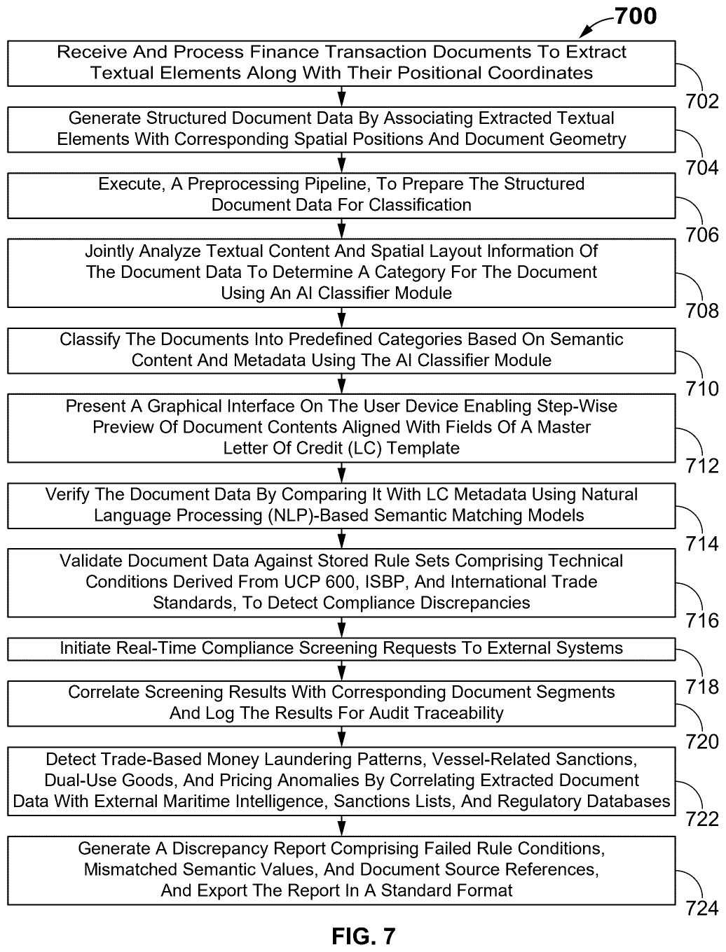

FIG. 7 exemplarily illustrates a flowchart 700 of a method for processing trade finance documents and performing automated compliance screening, according to an embodiment of the present invention. At step 702, the computing device 106 receives and processes trade finance transaction documents using an optical character recognition (OCR) module to extract textual elements along with their positional coordinates. The computing device 106 comprises at least one processor and memory storing program modules, and is in communication with the user device 102 for document upload and a database 108 for storing trade finance transaction documents.

At step 704, the computing device 106 generates structured document data by associating the extracted textual elements with corresponding spatial positions and document geometry using a layout-aware artificial intelligence (AI) model trained on document geometry and content position. At step 706, a preprocessing pipeline operably coupled to the processor and memory is executed to prepare the structured document data for classification.

At step 708, the computing device 106 jointly analyzes the textual content and spatial layout information of the document data to determine a category for the document using an AI classifier module. The AI classifier module comprises a multi-modal embedding layer representing each textual element as a combination of textual embeddings, two-dimensional spatial embeddings derived from the element's page location, and domain-role tags, and a plurality of transformer encoder layers configured to compute self-attention over both sequential textual order and spatial positions to generate context-aware representations.

At step 710, the AI classifier module classifies the documents into predefined categories based on semantic content and metadata. At step 712, a graphical interface is presented on the user device to enable step-wise preview of document contents aligned with fields of a master Letter of Credit (LC) template. At step 714, the computing device 106 verifies the document data by comparing it with LC metadata using natural language processing (NLP)-based semantic matching models via a semantic verification module. At step 716, the document data is validated against stored rule sets comprising technical conditions derived from UCP 600, ISBP, and international trade standards to detect compliance discrepancies via a rule management module.

At step 718, real-time compliance screening requests are initiated to external systems, including sanctions screening platforms, vessel intelligence services, and dual-use goods databases, via a financial crime risk control module. At step 720, screening results are correlated with corresponding document segments and logged for audit traceability. At step 722, the system detects trade-based money laundering patterns, vessel-related sanctions, dual-use goods, and pricing anomalies by correlating extracted document data with external maritime intelligence, sanctions list, and regulatory databases. At step 724, a discrepancy report is generated comprising failed rule conditions, mismatched semantic values, and document source references, and the report is exported in a standard format.

The system provides a user dashboard that displays a profile for each user, including a representation of task history for the corresponding transactional entity. The dashboard contains multiple tasks categorized under different categories, such as new tasks, assigned tasks, rejected tasks, and completed tasks, each visually differentiated by color coding for easy navigation. The dashboard further comprises graphical representations to demonstrate performance overviews and time spent on tasks. The performance overview graph illustrates various task statuses on a monthly basis, while the time spent graph shows daily task engagement. Filters may be applied to both graphs to display data over selected periods, such as six months for performance overview or one week for time spent.

The system enables viewing and managing tasks by category. Selecting a category presents an expanded view of all tasks assigned under that category. Each task may include a document, such as a letter of credit, which is associated with specific task categories. When a task is selected, the system displays a task confirmation interface, allowing the task to be added to the user's queue.

For assigned tasks, the system provides user profiles containing details such as user name and task-specific sections, including LC details, applicant, beneficiary, total bills, received date, and amount. The system supports multiple stages for each task, including completeness checks, data extraction, and rules validation. The completeness check stage links to relevant LC conditions and enables the system to recognize both original and duplicate documents, facilitating cross-verification against LC requirements. The system presents received documents alongside LC details, including bill of exchange, commercial invoice, bill of lading, packing list, certificate of origin, beneficiary certificates, and unclassified documents.

The system maintains a master LC document and tracks original LC documents provided by issuing banks. It incorporates amendments made to LCs by automatically updating the master LC and applying smart matching techniques to identify amended tags in sequential order. This automated handling eliminates the need for manual review of amendment sequences. The system also performs automated consistency checks for LC fields, including the description of goods or services, HS codes, unit prices, and quantities, using proprietary natural language processing models specifically trained for trade finance documents. Semantic matching is applied to goods descriptions across invoices, packing lists, and other documents to reduce false positives compared to simple string matching.

The system supports document reclassification, allowing users to manually reassign or reclassify documents to correct misclassifications or unclassified items. This reclassification capability contributes to continuous training of the system. During the extraction stage, the system presents extracted document data to the user, who can verify the information. Visual cues, such as color coding, highlight items requiring attention. The system further incorporates smart data capture techniques, enabling users to select data from document regions directly, which is automatically populated into corresponding fields without manual typing.

The rules validation stage of the system scrutinizes documents based on UCP, ISBP, and other consistency rule checks. Discrepancies are highlighted with explainability views, allowing users to review the specific values being compared and understand why a rule passed, failed, or was overridden. The system generates consolidated discrepancy reports for each LC and associated trade documents, which can be filtered based on system-identified or user-added discrepancies and exported in standard formats such as PDF.

The system also allows users to highlight passed or failed LC rule conditions and compare documents with LC details directly. Proprietary natural language processing techniques parse conditions from swift messages, such as MT 700, to validate presentation documents automatically against specified requirements, including signatures, dates, and beneficiary details.

Finally, the system provides a rules configuration interface, enabling users to log in and author rules within the rules engine. Users can enable or disable predefined UCP, ISBP, and consistency rules based on business requirements and create new rules. Each rule includes a name, description, tags, and operators, and a rule preview option is provided to explain the authored rules and the logic used during execution.

Advantageously, the system of the present invention leverages advanced artificial intelligence (AI) techniques to improve the effectiveness and efficiency of the trade finance operations and sanctions screening processes. The system enables the clients to reduce risks, improve throughput by up to 70% and significantly reduce false positives and missed red flags. The system performs an automated classification, extraction, and validation of information from low fidelity scanned images or documents using layout and position-based learning. The system performs automated interpretation of Letter of Credit (LC) conditions using natural language processing (NLP). The system automates the reconciliation against UCP and ISBP. The improved transaction increases the productivity to about 70% and significantly reduces the false positives in sanctions screening. Further, the system drastically reduces the missed red flags in TBML checks and improves the risk coverage and compliance level.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A system for processing trade finance documents and performing automated compliance screening, comprising:
a computing device comprising at least one processor and a memory storing a set of program modules;
at least one database in communication with the computing device via a network, the database is configured to store a plurality of trade finance transaction documents, and
a user device associated with a user in communication with the computing device via the network, configured to upload trade finance transaction documents to the computing device,
wherein the computing device is configured to:
receive and process finance transaction documents using an optical character recognition (OCR) module to extract textual elements along with their positional coordinates;
generate structured document data by associating extracted textual elements with corresponding spatial positions and document geometry using a layout-aware artificial intelligence (AI) model trained on document geometry and content position;
execute, a preprocessing pipeline operably coupled to the processor and memory, to prepare the structured document data for classification;
jointly analyze textual content and spatial layout information of the document data to determine a category for the document using an AI classifier module, wherein the AI classifier module operably coupled to the processor, comprises:
a multi-modal embedding layer configured to represent each textual element detected in the document as a combination of textual embeddings, two-dimensional spatial embeddings derived from the element's location on the page, and domain-role tags indicating the element's functional role in trade finance transactions, and
a plurality of transformer encoder layers configured to compute self-attention over both the sequential order of the textual elements and their corresponding spatial positions to generate context-aware representations;
classify the documents into predefined categories based on semantic content and metadata using the AI classifier module;
present a graphical interface on the user device enabling step-wise preview of document contents aligned with fields of a master Letter of Credit (LC) template;
verify the document data by comparing it with LC metadata using natural language processing (NLP)-based semantic matching models, via a semantic verification module operably coupled to the processor and memory;
validate document data against stored rule sets comprising technical conditions derived from UCP 600, ISBP, and international trade standards, to detect compliance discrepancies, via a rule management module operably coupled to the processor and memory;
initiate real-time compliance screening requests to external systems via a financial crime risk control module operably coupled to the processor and memory, wherein the external system including sanctions screening platforms, vessel intelligence services, and dual-use goods databases, wherein the financial crime risk control module correlates screening results with corresponding document segments of document data and logs the results for audit traceability;
correlate screening results with corresponding document segments and log the results for audit traceability;
detect trade-based money laundering patterns, vessel-related sanctions, dual-use goods, and pricing anomalies by correlating extracted document data with external maritime intelligence, sanctions list, and regulatory databases;
generate a discrepancy report for trade finance transaction documents, and export the report in a standard format;
enable rule customization by users via a graphical rule authoring interface linked to the rule management module, and
adaptively retrain the AI classifier module using human validation feedback incorporated into retraining cycles,
wherein the system is configured to operate autonomously or semi-autonomously, handle heterogeneous layouts and multi-language financial documents, and integrate with banking systems.

2. The system of claim 1, wherein the financial crime risk control module is configured to send structured document data to the external system to perform real-time compliance screening, and wherein the compliance screening requests comprise financial crime risk controls, the financial crime risk controls including sanctions screening, compliance checks, and trade-based money laundering (TBML) checks.

3. The system of claim 1, wherein the user device is configured to communicate with the computing device via the network using an application software or mobile application, web-based application, or desktop application executed in a computer-implemented environment.

4. The system of claim 1, wherein the user is allowed to register into the system using one or more user credentials to access the services provided by the computing device.

5. The system of claim 1, wherein the user device is enabled to access a trade finance management system via the network.

6. The system of claim 1, wherein the system includes a user-initiated reclassification module configured to reassign documents to updated categories based on user input or continuous learning feedback.

7. The system of claim 1, wherein the validation of document data further involves performing completeness checks for various documents requested or received by the user or other transactional entities under different fields, wherein the different fields include bill of exchange, commercial invoice, bill of lading, packing list, certification of origin, beneficiary's certificate and unclassified documents.

8. The system of claim 1, uses a visual selection-based data capture interface to extract data from document regions without manual typing, and wherein a document comparison engine maps structured data fields to LC terms to identify semantic and numeric discrepancies.

9. The system of claim 1, wherein the discrepancy report is generated for a Letter of Credit (LC) and one or more trade transaction documents linked to the LC, and wherein the discrepancy report comprises failed rule conditions, mismatched semantic values, and document source references.

10. The system of claim 1, wherein the graphical rule authoring interface allows users to define, test, and deploy rule conditions into the rule management module, and wherein the system further includes a task history profile associated with each transactional entity.

11. The system of claim 1, wherein the AI classifier module comprises a transformer-based architecture configured to jointly learn from textual content and spatial layout of trade finance documents, wherein the AI classifier module is configured to embed token-level semantic information together with positional coordinates of each token to enable recognition of visual document structure, wherein the AI classifier module includes the preprocessing pipeline configured to handle non-standard layouts, embedded tables, handwritten notes, and stamps within trade finance documents.

12. The system of claim 1, wherein the human validation feedback is captured from a user interface and stored in a structured format prior to integration into retraining cycles, wherein the structured human validation feedback is applied to retraining cycles through dynamic sample reweighting, and wherein the adaptive learning loop applies dynamic sample reweighting to adapt to customer-specific document structures and compliance requirements.

13. The system of claim 1, further comprising:
a dynamic rules engine configured to apply both predefined rule sets derived from international trade standards, including UCP 600 and ISBP, and adaptive user-defined rules for trade finance document validation; and
a trade finance common data model configured to standardize and structure extracted document data into normalized domain-specific entities including Letter of Credit (LC) terms, shipment details, invoicing elements, and compliance attributes,
wherein the dynamic rules engine operates on the standardized trade finance data model to detect discrepancies, compliance exceptions, and semantic mismatches across heterogeneous trade finance document formats.

14. The system of claim 1, wherein the AI classifier module is configured to generate domain-specific embeddings for trade finance documents, the embeddings comprising:
textual embeddings derived from the content of each token,
spatial embeddings derived from the positional coordinates of the token within the document layout, and
domain-role embeddings encoding functional trade finance attributes of the token, including document type roles, Letter of Credit (LC) field associations, and regulatory compliance indicators,
wherein the textual, spatial, and domain-role embeddings are fused into a unified multi-modal representation, enabling the AI classifier module to distinguish functionally equivalent terms across heterogeneous trade finance document formats.

15. A method for processing trade finance documents and performing automated compliance screening, comprising:
providing a computing device comprising at least one processor and a memory storing a set of program modules, at least one database in communication with the computing device via a network, and a user device associated with a user in communication with the computing device via the network, configured to upload trade finance transaction documents to the computing device, wherein the database is configured to store a plurality of trade finance transaction documents;
receiving and processing finance transaction documents using an optical character recognition (OCR) module to extract textual elements along with their positional coordinates;
generating structured document data by associating extracted textual elements with corresponding spatial positions and document geometry using a layout-aware artificial intelligence (AI) model trained on document geometry and content position;
executing, a preprocessing pipeline operably coupled to the processor and memory, to prepare the structured document data for classification;
jointly analyzing textual content and spatial layout information of the document data to determine a category for the document using an AI classifier module, wherein the AI classifier module operably coupled to the processor, comprises:
a multi-modal embedding layer configured to represent each textual element detected in the document as a combination of textual embeddings, two-dimensional spatial embeddings derived from the element's location on the page, and domain-role tags indicating the element's functional role in trade finance transactions, and
a plurality of transformer encoder layers configured to compute self-attention over both the sequential order of the textual elements and their corresponding spatial positions to generate context-aware representations;
classifying the documents into predefined categories based on semantic content and metadata using the AI classifier module;
presenting a graphical interface on the user device enabling step-wise preview of document contents aligned with fields of a master Letter of Credit (LC) template;
verifying the document data by comparing it with LC metadata using natural language processing (NLP)-based semantic matching models, via a semantic verification module operably coupled to the processor and memory;
validating document data against stored rule sets comprising technical conditions derived from UCP 600, ISBP, and international trade standards, to detect compliance discrepancies, via a rule management module operably coupled to the processor and memory;
initiating real-time compliance screening requests to external systems via a financial crime risk control module operably coupled to the processor and memory, wherein the external system including sanctions screening platforms, vessel intelligence services, and dual-use goods databases, wherein the financial crime risk control module correlates screening results with corresponding document segments of document data and logs the results for audit traceability;
correlating screening results with corresponding document segments and log the results for audit traceability;
detecting trade-based money laundering patterns, vessel-related sanctions, dual-use goods, and pricing anomalies by correlating extracted document data with external maritime intelligence, sanctions list, and regulatory databases;
generating a discrepancy report for trade finance transaction documents, and export the report in a standard format;
enabling rule customization by users via a graphical rule authoring interface linked to the rule management module, and
adaptively retraining the AI classifier module using human validation feedback incorporated into retraining cycles,
wherein the system is configured to operate autonomously or semi-autonomously, handle heterogeneous layouts and multi-language financial documents, and integrate with banking systems via an application programming interface (API) layer.

16. The method of claim 15, wherein the human validation feedback is captured from a user interface and stored in a structured format prior to integration into retraining cycles, wherein the structured human validation feedback is applied to retraining cycles through dynamic sample reweighting, and wherein the adaptive learning loop applies dynamic sample reweighting to adapt to customer-specific document structures and compliance requirements.

17. The method of claim 15, wherein the financial crime risk control module is configured to send structured document data to the external system to perform real-time compliance screening.

18. The method of claim 15, wherein the AI classifier module comprises a transformer-based architecture configured to jointly learn from textual content and spatial layout of trade finance documents.

19. The method of claim 15, wherein the AI classifier module is configured to embed token-level semantic information together with positional coordinates of each token to enable recognition of visual document structure, and wherein the AI classifier module includes the preprocessing pipeline configured to handle non-standard layouts, embedded tables, handwritten notes, and stamps within trade finance documents.

20. The method of claim 15, uses a visual selection-based data capture interface to extract data from document regions without manual typing.
